(19) United States
(12) Patent Application Publication
(10) Pub. No.: US 2007/0035200 A1
(43) Pub. Date: Feb. 15, 2007

(54) Microelectromechanical system comprising a beam that undergoes flexural deformation

(75) Inventors: Fabrice Casset, Tencin (FR); Karim Segueni, Saint Sauveur (FR); Arnaud De Grave, Grenoble (FR); Nicolas Abele, Paris (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignees: STMicroelectronics S.A., Montrouge (FR); Commisariat A L'Energie Atomique

(21) Appl. No.: 11/388,213

(22) Filed: Mar. 23, 2006

(30) Foreign Application Priority Data
Mar. 24, 2005 (FR) 05 02942

(51) Int. Cl. H01H 57/00; C23F 1/00; H02N 1/00

(52) U.S. Cl. 310/309; 200/181; 216/2

(57) ABSTRACT

A microelectromechanical system comprises a beam and an electrode coupled to the beam via electrostatic interaction. The beam is designed to undergo elastic flexural deformation and has an approximately constant cross section. The beam consists of several flat faces that extend over the length of the beam, each having a thickness of less than an external dimension of the cross section. A flexural vibration frequency of the beam is then increased compared with a solid beam of the same external dimensions. Such a microelectromechanical system is suitable for applications requiring very short transition times, or for producing high-frequency oscillators and resonators.

### BACKGROUND OF THE INVENTION

1. Field of the Invention

The present invention relates to a microelectromechanical system or MEMS, comprising a beam designed to undergo flexural deformation. It also relates to a process for producing such a microelectromechanical system.

2. Description of the Related Art

Various microelectromechanical systems intended to be integrated into an electronic device are known. For example, the article entitled “Vibrating RF MEMS for low-power wireless communications” by Clark T.-C. Nguyen, Proceedings, 2000 Int. MEMS Workshop (iMEMS'01), Singapore, Jul. 4-6, 2001, pp. 21-34, describes microelectromechanical systems of various configurations. Among these microelectromechanical systems, some comprise a beam intended to undergo elastic flexural deformation and others comprise a volume intended to exhibit what are called elastic contour variations. The microelectromechanical systems undergoing volume contour variations exhibit particularly high deformation frequencies, which are suitable for many applications. However, they are difficult to produce and consequently have a high cost price.

Microelectromechanical systems comprising a beam intended to undergo flexural deformation are simpler to produce and less expensive. However, the flexural deformation frequency of the beam is too low for certain applications.

FIGS. 1a and 1b show such a flexural-beam microelectromechanical system. FIG. 1a is a perspective view of the microelectromechanical system and FIG. 1b is a cross-sectional view in a mid-plane of the beam. The beam 1 has a defined length L along a longitudinal direction D and possesses a cross section in a plane perpendicular to the direction D that is approximately constant over at least a main part of the length L. The beam is designed to undergo elastic flexural deformation.

In the particular example shown, the beam 1 has a thickness t of less than the width w, so that the cross section is an elongate rectangle. Because of the small thickness t, the beam 1 is designed to undergo elastic flexural deformation so that the elementary portions of the beam 1 are displaced by vibrating in the direction N, parallel to the direction of the thickness t. The beam 1 may be mechanically linked to a substrate 100 of the microelectromechanical system via two links that are located at the ends of the beam and denoted by the references 2 and 3. The broken line V in FIG. 1b illustrates one possible deformation of a longitudinal line of the beam 1 when the latter undergoes flexural vibration.

It is known that such a beam can undergo flexural deformation in various modes, each characterized by a number of vibration nodes located along the length of the beam. It is also known that the beam may possess various cross sections, for example changing its thickness and its width. Finally, microelectromechanical systems exist in which the beam undergoes flexural deformation in various directions, especially with respect to the substrate 100.

The microelectromechanical system further includes at least one electrode 10 coupled to the beam via electrostatic interaction. To do this, the beam 1 may be made of a conductive material, or may possess a conductive coating, so that one part of the beam, located approximately facing a part P of the electrode 10, forms with the latter a capacitor. An electrical voltage U can then be applied between the beam 1 and the electrode 10. The voltage U generates an electrostatic force exerted by the electrode 10 on the beam 1, parallel to the direction N. The beam 1 then undergoes flexural deformation. Numerous beam and electrode configurations have been used, but they correspond to beam deformation rates that are too low for certain applications of the microelectromechanical system.

### BRIEF SUMMARY OF THE INVENTION

An embodiment of the present invention provides a microelectromechanical system that is both simple to produce and has high deformation rates.

To do this, the embodiment provides a microelectromechanical system comprising a beam of defined length in a longitudinal direction and at least one electrode coupled to the beam via electrostatic interaction, said beam being designed to undergo elastic flexural deformation and having a cross section in a plane perpendicular to said longitudinal direction that is approximately constant over at least a main part of the length of the beam. The beam comprises several flat faces extending over a main part of its length, which are joined together along lines parallel to the longitudinal direction and which each have a thickness less than at least one external dimension of the cross section of the beam. In other words, the beam of the microelectromechanical system is of cut-out cross section, or is a hollow beam.

Thanks to such a cross section, the beam can undergo flexural deformation at higher rates, so that the microelectromechanical system can be used for applications that require rapid transitions or high oscillation frequencies. In particular, the microsystem can be incorporated into a switch or into an oscillator, or it may be used as an accelerometer or as a resonator.

The thickness of at least one of the flat faces may for example be less that one quarter the external dimension of the cross section. Such a beam possesses a relatively low weight, so that, when it deforms, it exhibits little inertia, while still maintaining a high stiffness. Its deformations are therefore rapid.

Optionally, the electrode may be located between a substrate of the microelectromechanical system and the beam. The microelectromechanical system then has a particularly compact configuration.

One advantage of a microelectromechanical system according to some embodiments of the invention stems from the fact that the beam undergoes flexural deformation. Given that the flexural deformations of the beam may have a large amplitude, the beam and the electrode can nevertheless be fabricated easily, without requiring high precision in the respective dimensions and locations of the beam and of the electrode.

An embodiment of the invention also provides a process for fabricating a flexural-beam microelectromechanical system of the above type. Such a process comprises the following steps:

a) forming, on a rigid substrate, a portion made of a first material being able to be selectively etched with respect to a second material;

b) forming, on an opposite side of the portion of the first material from the substrate, a beam made of the second material, said beam extending above the portion of the first material over a defined length along a longitudinal direction; and

c) etching the first material selectively with respect to the second material so as to form a first empty space between the substrate and the beam.

The process further includes a step of forming at least one electrode on the substrate, said electrode being designed to be coupled to the beam via electrostatic interaction.

According to one embodiment of the invention, step b) of the process comprises the formation of several flat faces that extend over at least a main part of the length of the beam and form, in a plane perpendicular to the longitudinal direction, a cross section that is approximately constant over said main part of the length of the beam, said flat faces being joined together along lines parallel to the longitudinal direction and each having a thickness of less than at least one external dimension of the cross section.

Such a process may be particularly simple to implement when the cross section of the beam is a closed cross section, of square or rectangular external shape, formed by four pairwise perpendicular flat faces, or when the cross section is of U or H shape. This is because the beam may then be produced by combining masking steps, for masking specified parts of the microelectromechanical system, material deposition steps and etching steps that are simple and well-controlled. Such steps may for example be borrowed from the technologies used for fabricating integrated electronic circuits. In particular, the beam may advantageously be based on silicon or on a silicon-germanium alloy. This is because particularly well-controlled selective etching processes exist for these materials, allowing defined cross sections to be accurately produced.

The microelectromechanical system can therefore be produced on an integrated-circuit fabrication line. By appropriately selecting the materials used to produce the microelectromechanical system, it may in particular be carried out at the front end of the integrated-circuit fabrication line. In this case, the microelectromechanical system may be produced on a substrate intended also to bear an electronic circuit. One particularly compact and inexpensive device can then be obtained, which incorporates both the microelectromechanical system and the electronic circuit in order to carry out a defined complex function. The microelectromechanical system and the electronic circuit may even be fabricated on the same fabrication line.

The flat faces of the beam may be produced using various methods.

According to a first method, the beam is formed directly so that it initially has several flat faces. It then possesses, right from its formation, the definitive cross section.

According to a second method, an elongate structure may firstly be formed, and then etched so that the flat faces consist of residual portions of the elongate structure. The process may then further include a step d) of forming a second empty space between at least two of the flat faces of the beam. In this case, steps c) and d) are preferably carried out simultaneously, especially so as to reduce the number of steps in the process for fabricating the microelectromechanical system.

According to one particular way of implementing this second method of producing the beam, the beam may be formed in step b) so that the cross section at least partly surrounds a core of a temporary material extending over the main part of the length of the beam. Step d) then comprises the selective removal of the core so as to form the said second empty space.

Optionally, the electrode may be formed on the substrate before step a). It may thus be placed between the substrate and the beam, in the final state of the microelectromechanical system.

### BRIEF DESCRIPTION OF THE SEVERAL VIEWS OF THE DRAWING(S)

Other features and advantages of the present invention will become apparent in the following description of non-limiting illustrative examples, with reference to the appended drawings in which:

FIGS. 1a and 1b, already described, show a microelectromechanical system as known from the prior art;

FIGS. 2a-2f illustrate steps in a process for fabricating a flexural-beam microelectromechanical system according to the invention, the beam having a cavitied square cross section; and

FIGS. 3a-3d illustrate alternative embodiments of the invention.

### DETAILED DESCRIPTION OF THE INVENTION

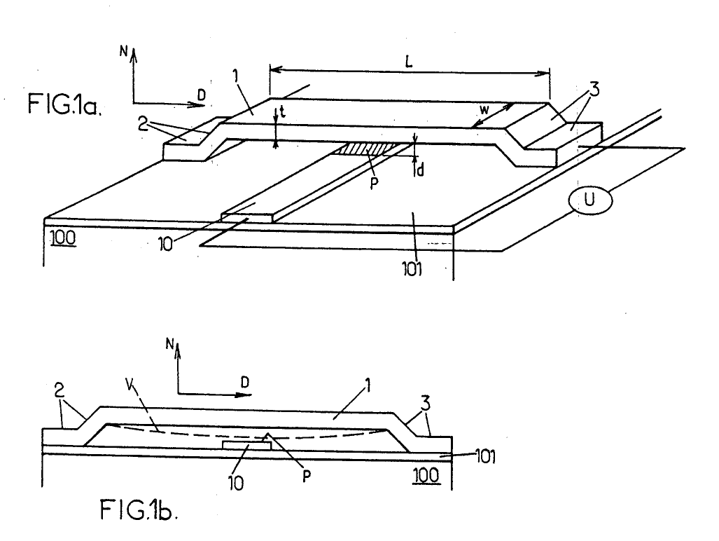

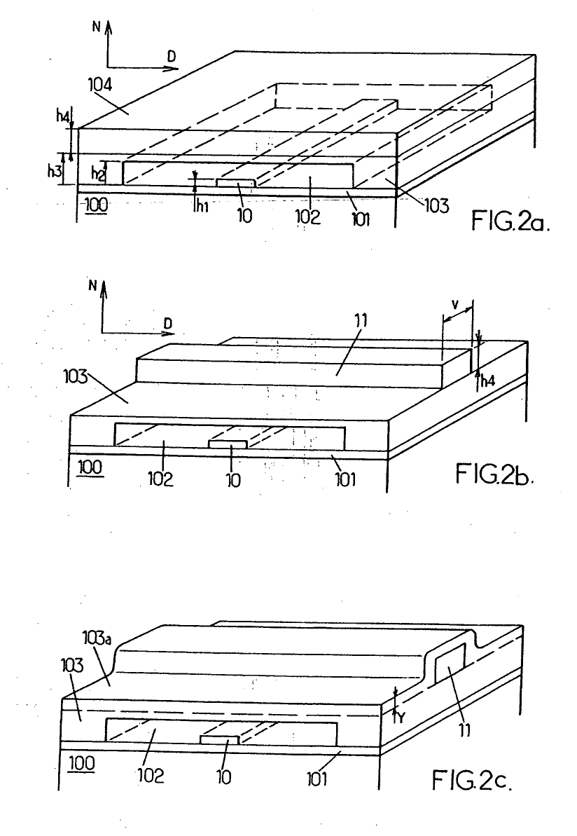

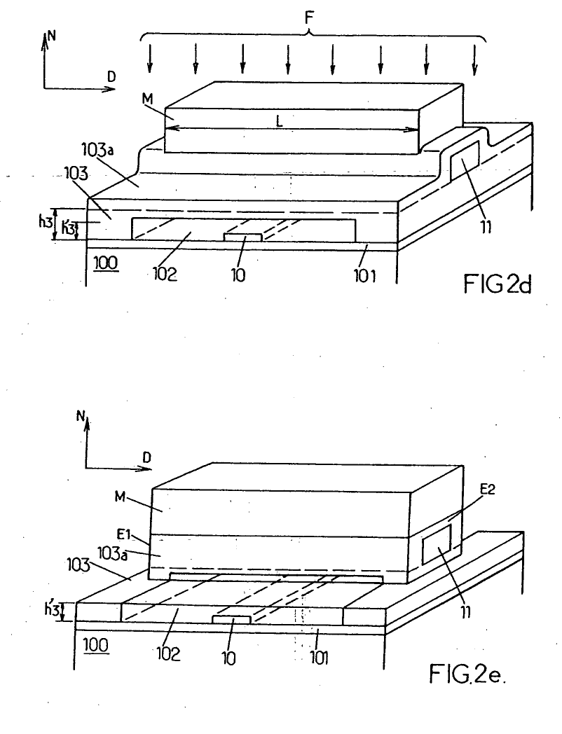

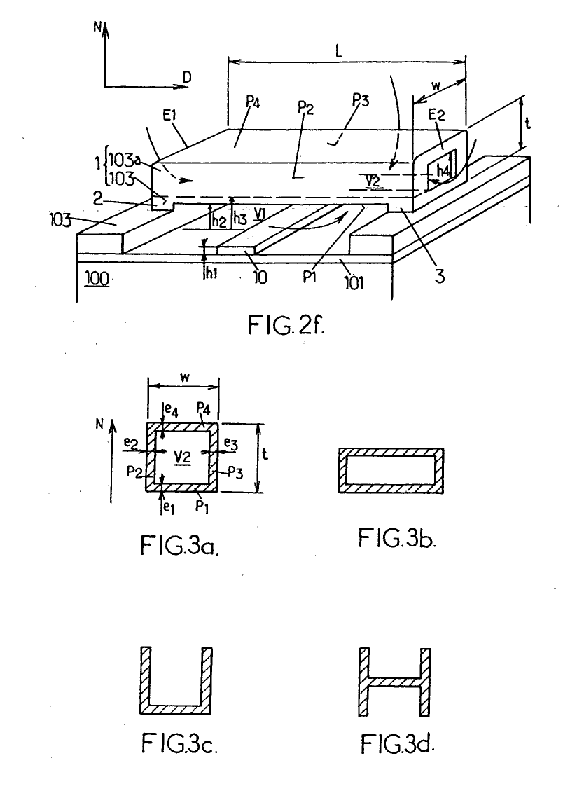

For the sake of clarity, the various elements shown in these figures have not been drawn to scale. FIGS. 1 and 2a-2f are perspective views of a substantially plane substrate, on which a microelectromechanical system according to the invention is produced. The substrate is in the lower part of each figure, and N denotes a direction perpendicular to the surface of the substrate, directed upwards in the figures. In the rest of the description, the terms “on”, “under”, “lower” and “upper” are used with reference to this orientation. Furthermore, in all the figures, identical references correspond to identical elements.

A process for fabricating a microelectromechanical system according to the invention will now be described with reference to FIGS. 2a-2f. In this description, elementary steps of the process that are known from the fabrication of an integrated electronic circuit will not be explained in detail. Only the succession of individual steps for producing the microelectromechanical system will be described here.

According to FIG. 2a, a substrate comprises a substrate base 100, for example made of single-crystal silicon (Si) coated with a layer 101 of silica (SiO₂). The layer 101 is electrically insulating. A strip 10 is formed on the layer 101, in a central part thereof. The strip 10 may be made of a silicon-germanium (Si—Ge) alloy, which is electrically conductive. The strip 10 is covered by a volume 102 of silicon, the upper surface of which is planarized by CMP (Chemical-Mechanical Polishing). The volume 102 itself is covered by a volume 103 of silicon-germanium alloy, the upper surface of which is also planarized. Finally, the volume 103 is covered with a silicon layer 104. Such a structure is easily produced by an expert in the design and fabrication of integrated circuits, by combining silicon or silicon-germanium alloy epitaxial deposition, masking and etching steps. In particular, the substrate base 100, the layer 101 and at least part of the volume 102 may be obtained from a substrate used in SOI (Silicon On Insulator) technology for fabricating integrated electronic circuits, and commercially available. The materials of the strip 10, of the volumes 102 and 103, and also of the layer 104 are therefore substantially single-crystal materials.

The respective thicknesses of the strip 10, the volume 102, the volume 103 and the layer 104 in the direction N are denoted by h₁, h₂, h₃ and h₄, h₁ being less than h₂, which is itself less than h₃. The following approximate values may for example be taken: h₁ is equal to 0.02 μm (microns), h₂ is equal to 1.0 μm, h₃ is equal to 1.1 μm and h₄ is equal to 0.8 μm. In the direction D, the strip 10, the volume 102 and the volume 103 have respective widths that increase in this order.

The layer 104 is then covered with a mask (not shown) in the form of a strip parallel to the direction D, of width v equal to about 0.8 μm. The layer 104 is then etched outside the mask, for example using a selective etching process in which the silicon is preferentially etched over a silicon-germanium alloy. Such a selective etching process is well known to those skilled in the art and will not be discussed here. This etching is referred to in the rest of the description as the first etching step. A silicon strip 11, parallel to the direction D and of width v and thickness h₄, is thus formed on the volume 103 (FIG. 2b). The mask is then removed.

A silicon-germanium alloy is then deposited on the volume 103 and on the strip 11 by epitaxial growth. An alloy layer 103a is thus formed, which is conformal with respect to the relief of the strip 11 above the volume 103. The deposition of the layer 103a is continued until the layer 103a has a thickness y of about 0.1 μm (FIG. 2c).

A second mask, with the reference M in FIG. 2d, is formed on the layer 103a, plumb with the strip 11. The mask M has a width greater than v, for example equal to 1.0 μm, along the direction parallel to the surface of the base 100 and perpendicular to the direction D. Furthermore, the mask M has a length L along the direction D that is intermediate between the respective widths of the volumes 102 and 103. The mask M is positioned on the layer 103a so as to be centered with respect to both the strip 11 and the volume 102, in a plane parallel to the surface of the base 100.

A second etching step is then carried out, using a flux F of particles accelerated along the direction N, but in the opposite sense thereto. The flux F is directed against the upper surface of the layer 103a (FIG. 2d). This second etching operation is continued until the exposed parts of the layer 103a have been completely removed. Optionally, the second etching step may be continued so as to also remove respective upper parts of the volumes 103 and then 102 (FIG. 2e). The volumes 102 and 103 then have approximately equal respective thicknesses in the direction N, these being denoted by h′₃ in FIGS. 2d and 2e. For example h″₃ is equal to about 0.8 μm. At the same time, the anisotropic etching step forms two end faces E₁ and E₂ located on either side of the strip 11 along the direction D.

The mask M is removed and a third etching step, of the anisotropic type, is carried out in order to selectively remove those silicon parts substantially devoid of germanium that remain above the silica layer 101. A selective etchant may be used for this third etching step, which is identical to that employed in the first etching step. The residual part of the volume 102 is thus removed, via the faces of the volume 102 that are exposed during the anisotropic etching by the flux F. A first empty space V₁ is thus formed between the layer 101 and the residual upper part of the layer 103 (FIG. 2f). The empty space V₁ has a thickness h₂-h₁ between the beam 1 and the strip 10 along the direction N.

A bridge structure is thus obtained, which is linked to the layer 101 via two mechanical links 2, 3 located at opposed ends of the structure along the direction D. The links 2, 3 are formed by residual lateral parts of the volume 103. The bridge structure is made of an electrically conductive silicon-germanium alloy. It is in the shape of a beam placed horizontally above the strip 10, whilst still being electrically isolated therefrom. This beam is denoted by the reference 1 in FIG. 2f. The beam 1 has a length along the direction D equal to that of the mask M, that is to say equal to L. L may for example be equal to 10 μm. D is then the longitudinal direction of the beam 1.

The silicon strip 11 is removed at the same time as the residual part of the volume 102 during this third etching operation. It is removed via the end faces E₁ and E₂ so that a second empty space V₂, or hollow region, is formed between the residual parts of the layers 103 and 103a. In FIG. 2f, the curved arrows show the directions in which the etchant gains access to the silicon parts containing no germanium that are intended to be removed.

The beam 1 thus becomes a hollow beam—the empty space V₂ is located in the core of the beam 1, instead of the strip 11. For this reason, the strip 11 is called the core of the beam 1, which is made of a temporary material that is then removed.

The beam 1 has a cross section of external width w(=v+2y) of 1.0 μm (FIG. 3a). The four sides, or walls, of this cross section are formed by the pairwise orthogonal flat faces P₁, P₂, P₃ and P₄ and are joined by their edges parallel to the direction D. The flat face P₁ is formed by an upper part of the volume 103, of thickness e₁=h₃-h₂, equal to 0.1 μm in the example described here. The flat faces P₂, P₃ and P₄ correspond to residual parts of the layer 103a, which were protected by the mask M during the second etching step. They each have a thickness approximately equal to y, that is to say about 0.1 μm, denoted by e₂, e₃ and e₄ in FIG. 3a. The thicknesses e₁-e₄ are less than the external width w.

The external thickness of the beam 1 in the direction N, denoted by t, is approximately equal to the sum of h₄, y and h₃-h₂. It is equal to about 1.0 μm. The thicknesses e₁-e₄ are therefore also less than t. The beam 1 therefore has a square cross section (FIG. 3a).

Many adaptations may be introduced into the beam fabrication process that has just been described. Among these adaptations, mention may be made of the following:

the dimensions of the beam, i.e., its length L, its internal width v, its internal height h₄, its external width w and its external thickness t may be varied;

the beam may have a cross section of rectangular shape (FIG. 3b), a U shape (FIG. 3c) or an H shape (FIG. 3d), with orientations that can vary relative to the direction N;

the beam may be made of silicon. In this case, the layer and volume portions that are selectively etched during the process for fabricating the microelectromechanical system may be made of a silicon-germanium alloy. Selective etching steps, in which the alloy is selectively etched with respect to silicon portions containing no germanium, are also known to those skilled in the art and may be employed in a manner equivalent to that which has been described in detail;

the beam may be made of an electrically insulating material and at least partly covered with a layer of electrically conductive material; and, finally,

the supports 2 and 3 may be located at points along the length of the beam 1 other than the ends of the beam along the direction D. In particular, the beam may be mechanically linked to the substrate 100 via at least one link located at a point along the length of the beam that corresponds to a node of a flexural vibration eigenmode of the beam.

The table below compares the flexural vibration frequencies of a beam resulting from the fabrication process that has been described in detail above. These frequencies are given for the first five vibration eigenmodes of the beam and are compared with those of a beam of the same length (10 μm) but with a solid square cross section having sides of 1.0 μm. They are expressed in megahertz (MHz).

| Flexural vibration | Beam according to | |
|---|---|---|
| eigenmodes | the invention | Solid beam |
| 1 | 82.884 | 74.326 |
| 2 | 87.386 | 77.178 |
| 3 | 90.874 | 191.909 |
| 4 | 108.058 | 198.449 |
| 5 | 113.131 | 235.533 |

This shows that the invention allows the flexural vibration frequency of a beam to be increased by about 12% for the first eigenmode relative to a solid beam having identical external dimensions. Likewise, the flexural vibration frequency of the second eigenmode is increased by about 9%. For the following eigenmodes the invention results in a decrease in the vibration frequency, thereby allowing the vibration frequency to be adjusted according to the application of the microelectromechanical system.

As a complementary illustrative example of the invention, the inventors fabricated a second hollow beam, of 500 μm in length with a square cross section of external dimensions 60 μm×60 μm and formed from four flat faces each 10 μm in thickness. The first flexural vibration eigenmode of such a beam has a frequency of 2.1 MHz. For comparison, a solid beam of the same length and the same external dimensions has a first flexural vibration eigenmode frequency of between 1.80 and 1.85 MHz.

Finally, a third hollow beam was produced, of 50 μm in length with a square cross section of 8 μm×8 μm external dimensions. This third beam consisted of four flat faces each 1.4 μm in thickness. It has a first flexural vibration eigenmode frequency of 24.5 MHz, whereas a solid beam of the same external dimensions has a corresponding frequency of about 23 MHz.

The strip 10 constitutes the electrode of the microelectromechanical system and is coupled to the beam 1 via electrostatic interaction. In other words, an electric field is present in the separating space lying between the beam 1 and the strip 10 when an electrical voltage is applied between the beam 1 and the strip 10. This electric field exerts a force on the beam 1 parallel to the direction N. Alternatively, the electrode may comprise a gate of an MOS transistor.

Optionally, the microelectromechanical system may further include a second electrode coupled to the beam 1 via electrostatic interaction. Such a second electrode may be necessary for certain devices that incorporate a flexural-beam microelectromechanical system according to the invention. In this case, the two electrodes may be an electrode for exciting the vibrations of the beam 1 and an electrode for detecting the said vibrations, respectively. When the detection electrode consists of the gate of an MOS transistor, an electrical signal caused by vibration of the beam is detected, and this is directly amplified in the form of a main current flowing between the source and the drain of the transistor. This main current is modulated by the variations in the electrical potential of the gate, which are caused by the bending of the beam 1.

A flexural-beam microelectromechanical system as described above can be incorporated into various electromechanical devices. When the device is a microswitch, the rapid deformation of the beam allows the electrical circuit to be opened particularly rapidly. When the device is an accelerometer, this is suitable for measuring greater accelerations that would result in saturation, or possibly fracture, of accelerometers with a flexural beam having the form of a thin flexible plate.

When the device incorporating a microelectromechanical system according to the invention is an oscillator or a resonator, the oscillation eigenfrequency or the first resonant frequencies thereof are particularly high and suitable for a large number of applications. Furthermore, the quality factor of such a resonator may be particularly high when the beam is made of a crystalline or even single-crystal material. This may be the case in particular when the beam is made of silicon and contains no germanium, as in this case it may have a particularly small quantity of crystal defects.

Finally, the microelectromechanical system that has been described in detail is suitable for being produced in the front end of an integrated-circuit fabrication line. Such a microelectromechanical system according to the invention may also be produced in the back end of an integrated-circuit fabrication line. In this case, the beam 1 may be made of a nitride-type material, the electrode 10 may be made of gold and the volume 102 may be made of a resin or polymer. Given that the beam 1 is then electrically insulating, it must be equipped with a counterelectrode, which may also be made of gold. This counterelectrode is placed on the beam 1 facing the electrode 10 so as to interact with the latter. Furthermore, a microelectromechanical system produced in the back end of the fabrication line may be placed above an integrated circuit produced on the substrate, so that the level of integration obtained for the circuit/microsystem assembly is greater. Such an arrangement is referred to as “integration above IC” (IC stands for “Integrated Circuit”).

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A microelectromechanical system, comprising:
a beam of a defined length in a longitudinal direction; and
a fixed electrode coupled to the beam via electrostatic interaction, said beam being configured to undergo elastic flexural deformation and having a cross section in a plane perpendicular to said longitudinal direction that is approximately constant over at least a main part of a length of the beam, the beam having several flat faces extending over the main part of the length of the beam, said flat faces being joined together along lines parallel to the longitudinal direction and each having a thickness less than at least one external dimension of the cross section.

2. The microelectromechanical system according to claim 1, wherein the thickness of at least one of the faces of the beam is less than one quarter said external dimension of the cross section.

3. The microelectromechanical system according to claim 1, wherein the cross section is a closed cross section having a square or rectangular external shape, formed by four pairwise perpendicular flat faces.

4. The microelectromechanical system according to claim 1, wherein the cross section is of U or H shape.

5. The microelectromechanical system according to claim 1, wherein the beam is substantially comprised of silicon or a silicon-germanium alloy.

6. The microelectromechanical system according to claim 1, wherein the beam is mechanically linked to a substrate bearing the electrode, via a link located at one end of the beam.

7. The microelectromechanical system according to claim 1, wherein the beam is mechanically linked to a substrate bearing the electrode, via a link located at a point along the length of the beam corresponding to a node of a flexural vibration eigenmode of the beam.

8. The microelectromechanical system according to claim 1, wherein the electrode comprises a gate of an MOS transistor.

9. The microelectromechanical system according to claim 1, wherein the electrode is an excitation electrode, and further comprising a detection electrode, each of the electrodes coupled, via an electrostatic interaction, with the beam.

10. The microelectromechanical system according to claim 1, comprising a switch including the beam and fixed electrode.

11. The microelectromechanical system according to claim 1, comprising an accelerometer including the beam and fixed electrode.

12. The microelectromechanical system according to claim 1, comprising an oscillator including the beam and fixed electrode.

13. The microelectromechanical system according to claim 1, comprising a resonator including the beam and fixed electrode.

14. A process for fabricating a microelectromechanical system, comprising:
a) forming a portion made of a first material on a rigid substrate, said first material being able to be selectively etched with respect to a second material;
b) forming, on an opposite side of the portion of the first material from the substrate, a beam made of the second material, said beam extending above the portion of the first material over a defined length along a longitudinal direction, the beam having several flat faces that extend over a main part of the length of the beam and form, in a plane perpendicular to said longitudinal direction, a cross section that is approximately constant over said main part of the length of the beam, said faces being joined together along lines parallel to the longitudinal direction and each having a thickness of less than at least one external dimension of the cross section;
c) etching the first material selectively with respect to the second material so as to form a first empty space between the substrate and the beam;
d) forming at least one electrode on the substrate, said electrode being configured to be coupled to the beam via electrostatic interaction.

15. Process according to claim 14, which further includes a step e) of forming a second empty space between at least two of the flat faces of the beam.

16. Process according to claim 15, wherein the beam is formed, in step b), so that the cross section at least partly surrounds a core of a temporary material extending over the main part of the length of the beam, and wherein step e) comprises the selective removal of said core so as to form said second empty space.

17. Process according to claim 15, wherein steps c) and e) are carried out simultaneously.

18. A method, comprising:
forming a first layer of material on a surface of a substrate of semiconductor material;
forming a second layer over the first layer;
forming a temporary strip over the second layer;
forming a third layer over the temporary strip and second layer so as to enclose top and sides of the temporary strip;
etching the second and third layers such that a remaining portion of the third layer extends over the top and sides of the temporary strip, and a remaining portion of the second layer extends under the temporary strip and contacts the remaining portion of the third structural layer at the sides of the temporary strip; and
removing the temporary strip and the first layer such that the remaining portions of the second and third layers form a hollow beam extending above a portion of the substrate.

19. The method of claim 18, comprising forming, prior to forming the first layer, an electrode on the surface of the substrate, positioned such that when the first layer is removed, the hollow beam extends above the electrode.

20. The method of claim 18, comprising forming, prior to forming the first layer, a transistor in the substrate, positioned such that when the first layer is removed, the hollow beam extends above a gate region of the transistor.

21. A device comprising:
a substrate of semiconductor material; and
a beam coupled to the substrate and extending over a portion thereof, the beam having a hollow region enclosed on three sides by faces of the beam and extending substantially along a length thereof.

22. The device of claim 21 wherein the hollow region is enclosed on four sides by faces of the beam, and wherein the beam has a cross sectional shape selected from among a square and a rectangle.

23. The device of claim 21 wherein the beam has a cross sectional shape selected from among a U shape and an H shape.

24. The device of claim 21, comprising an electrode positioned on the substrate such that the beam extends over the electrode, the electrode being configured to be capacitively coupled to the beam.

25. The device of claim 21 wherein the beam is coupled at first and second ends to the substrate.

26. The device of claim 21 wherein the beam is coupled to the substrate at an eigenmode flexural vibration node of the beam.

27. The device of claim 21 wherein a wall thickness of the beam, extending from the hollow region to an outer face thereof, is less than one quarter of any external dimension of the beam.
